(19) United States
(12) Patent Application Publication
(10) Pub. No.: US 2008/0300520 A1
(43) Pub. Date: Dec. 4, 2008

(54) Exercise Machine for Burning Body Fat and Increasing Muscle

(75) Inventor: In-Chul Shin, Seoul (KR)

Correspondence Address: CANTOR COLBURN, LLP, 20 Church Street, 22nd Floor, Hartford, CT, 06103, US

(73) Assignee: SIMON TRADING CO., LTD., Seoul (KR)

(21) Appl. No.: 11/571,765

(22) PCT Filed: Oct. 27, 2006
(86) PCT No.: PCT/KR2006/004403

§ 371 Date: Jan. 8, 2007

(30) Foreign Application Priority Data
Nov. 1, 2005 (KR) 10 -2005-0103769
Jun. 12, 2006 (KR) 10-2006-0052650
Oct. 11, 2006 (KR) 10-2006-0098918

(51) Int. Cl. A61H 1/00

(52) U.S. Cl. 601/49

(57) ABSTRACT

An exercise machine for burning fat and strengthening muscles is provided. The exercise machine includes a base frame (50), a drive unit (60), an undulator (RD), and a floorboard (80). The base frame (50) is substantially horizontal. The drive unit (60) is disposed on one side of the base frame (50), and provides driving force. The undulator (RD) is disposed at a top of the base frame (50), and undulates three-dimensionally through the driving force provided by the drive unit (60). The floorboard (80) is connected to the undulator (RD), undulates according to the three-dimensional undulating of the undulator (RD), and provides a user mounted thereon with fat burning and muscle strengthening three-dimensional exercise. The floorboard (80) undulates three-dimensionally by means of the undulator (RD), providing exercise required to burn fat and strengthen muscles.

### TECHNICAL FIELD

The present invention relates to a sporting apparatus for performing physical exercise, and more particularly, to a sporting apparatus for burning body fat and strengthening muscles.

### BACKGROUND ART

A variety of exercise and fitness machines are available for home or fitness club use. Users can select and use such machines for toning or strengthening their bodies. These exercise and fitness machines are passive-type machines, which users must exert force upon or otherwise operate to gain exercising benefits. By actively operating the machine to expand and contract a user's muscles, the user may derive physical benefits. One such exercise machine is proposed in Korean Patent No. 283875, which is hereby incorporated by reference.

The training apparatus for increasing muscular strength outlined in Korean Patent No. 283875 includes a base installed on a horizontal surface, a post installed at the front of the base, a floorboard installed on the base and capable of upward and downward movement for a user to place his/her feet on, a drive unit disposed within the base for undulatingly raising either side of the floorboard in a seesawing motion, and a control panel installed on the post for controlling the operation of the drive unit.

Here, the drive unit includes a driving source mounted on the base, a pair of driving pulleys fixed to a shaft of the driving source, a pair of driven pulleys, with the driven pulleys disposed respectively at either side of the driving pulleys and connected thereto through a belt, a pair of eccentric shafts inserted respectively in each driven pulley to form an overall obtuse angle, a bracket installed on the base and rotatably supporting either end of each eccentric shaft, and a connecting rod rotatably connected at its lower end to both ends of each eccentric shaft protruding from the bracket and at its upper end is rotatably connected to the bottom surface of the floorboard, so that the connecting rod moves the floorboard in a seesawing motion through the rotation of each eccentric shaft.

In the above structure, each driving pulley rotates via a motor, and the rotating force is transferred through a belt to each driven pulley, that rotates the eccentric shaft. Thus, when an inclined portion moves in a circular motion, the bottom end of the connector also moves circularly, while the top end thereof only moves vertically up and down. Therefore, the floorboard is alternately raised and lowered.

With this type of operation, a user does not have to rely on his/her muscles for movement, which is accomplished by the operation of the drive unit, to achieve muscle strengthening as well as relief of fatigued muscles.

### DISCLOSURE

### Technical Problem

However, because the floorboard moves only in two dimensions—i.e., a left and right or an up and down seesawing movement, the exercise benefits derivable from this type of apparatus are limited.

Additionally, in this type of fitness apparatus of the related art, it is difficult to accurately install the eccentric shafts formed on a pair of pulleys in mutual opposition, making manufacturing difficult and reducing output. Also, after prolonged use, the belts are prone to slacken and slip so that the eccentric shafts cannot maintain an accurate, mutually opposite disposition, leading to malfunction and unreliability. In this case, the connecting rod or the eccentric shafts, etc. are likely to break, further compromising reliability.

### Technical Solution

Accordingly, the present invention is directed to a sporting apparatus that substantially obviates one or more problems due to limitations and disadvantages of the related art.

An object of the present invention is to provide a sporting apparatus for burning fat and strengthening muscles that operates three-dimensionally and moves as one unit, providing fat burning and muscle strengthening benefits for a user.

Another object of the present invention is to provide a sporting apparatus for burning fat and strengthening muscles with a simple structure and assembly, that can easily be manufactured, and that prevents rupturing and breaking of its components even when operating 3-dimensionally.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, there is provided an exercise machine for burning fat and strengthening muscles, including: a base frame being substantially horizontal; a drive unit disposed on one side of the base frame, for providing driving force; an undulator disposed at a top of the base frame, for undulating three-dimensionally through the driving force provided by the drive unit; and a floorboard connected to the undulator and undulating according to the three-dimensional undulating of the undulator, for providing a user mounted thereon with fat burning and muscle strengthening three-dimensional exercise.

It is to be understood that both the foregoing general description and the following detailed description of the present invention are exemplary and explanatory and are intended to provide further explanation of the invention as claimed.

### ADVANTAGEOUS EFFECTS

The above-described exercise machine for burning fat and strengthening muscles according to the present invention has a simple structure for a driving unit, facilitating its installation, provides integration of components to prevent breaking and rupture of components, and provides a safe and smooth 3-dimensional exercising device for burning body fat and strengthening muscles.

Also, the exercise machine provides convenience and better exercising effects by allowing the adjusting of the range of 3-dimensional movement of the floorboard even during operation.

Furthermore, undulation of the floorboard can be safely controlled using the undulation limiter, so that excessive undulation of the floorboard leading to user injury can be prevented.

Moreover, when a metal bar is installed on the base frame, not only undulating exercise can be provided, but also horizontal bar exercises can be provided. Additionally, the addition of a seat installed on the floorboard can provide an entertaining exercising experience similar to riding a horse.

### DESCRIPTION OF DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a perspective view of a sporting apparatus according to a first embodiment of the present invention;

FIG. 2 is an exploded perspective view showing components of the sporting apparatus in FIG. 1 that provide undulating movement;

FIG. 3 is a sectional side view showing the components in FIG. 2 in an assembled state;

FIG. 4 is a side view showing the components in FIG. 2 before operation;

FIG. 5 is a side view showing the components in FIG. 2 during operation;

FIG. 6 is an exploded perspective view showing the components in FIG. 2 according to a second embodiment of the present invention;

FIG. 7 is a sectional side view showing the components in FIG. 6 in an assembled state;

FIG. 8 is a side view showing the components in FIG. 2 according to the third embodiment of the present invention;

FIG. 9 is a side view showing the components in FIG. 2 according to the fourth embodiment of the present invention;

FIG. 10 is an exploded perspective view showing the components in FIG. 2 according to the fifth embodiment of the present invention;

FIG. 11 is a perspective view showing the components in FIG. 10 in an assembled state;

FIG. 12 is a sectional side view showing the components in FIG. 10 in an assembled state;

FIG. 13 is a side view showing the components in FIG. 10 during operation;

FIG. 14 is a perspective view showing the components in FIG. 2 according to the sixth embodiment of the present invention;

FIG. 15 is a perspective view showing the components in FIG. 2 according to the seventh embodiment of the present invention;

FIG. 16 is a perspective view showing the components in FIG. 2 according to the eighth embodiment of the present invention;

FIG. 17 is a perspective view showing the components in FIG. 2 according to the ninth embodiment of the present invention;

FIG. 18 is a side view showing the components in FIG. 17 during operation;

FIG. 19 is an exploded perspective view showing the components in FIG. 2 according to the tenth embodiment of the present invention;

FIG. 20 is a perspective view showing the components in FIG. 19 in an assembled state;

FIG. 21 is a side view showing the components in FIG. 19 during operation;

FIG. 22 is a side view showing the components in FIG. 2 according to the eleventh embodiment of the present invention;

FIG. 23 is a perspective view showing the assembly of a post on an exercise machine for burning fat and strengthening muscle according to an embodiment of the present invention;

FIG. 24 is an exploded perspective view showing the assembly of a seat to an exercise machine for burning fat and strengthening muscle according to an embodiment of the present invention;

FIG. 25 is side view showing the seat in FIG. 24 during operation; and

FIG. 26 is a perspective view of the seat in FIG. 24 according to another embodiment of the present invention.

### BEST MODE

Reference will now be made in detail to the preferred embodiments of the present invention, examples of which are illustrated in the accompanying drawings. Wherever possible, the same reference numbers will be used throughout the drawings to refer to the same or like parts.

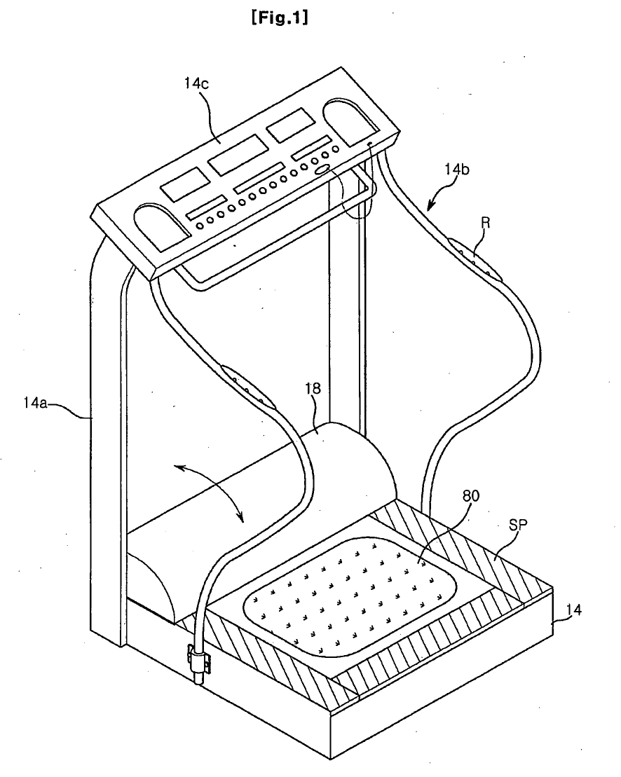

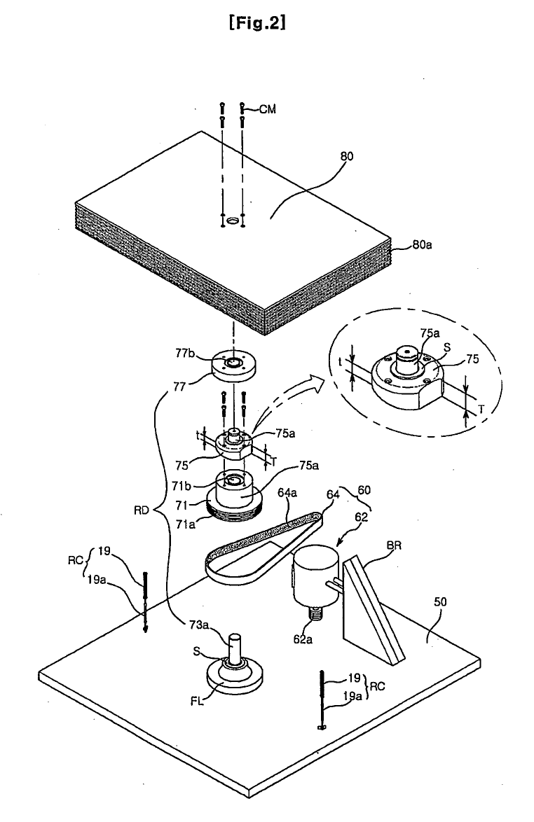

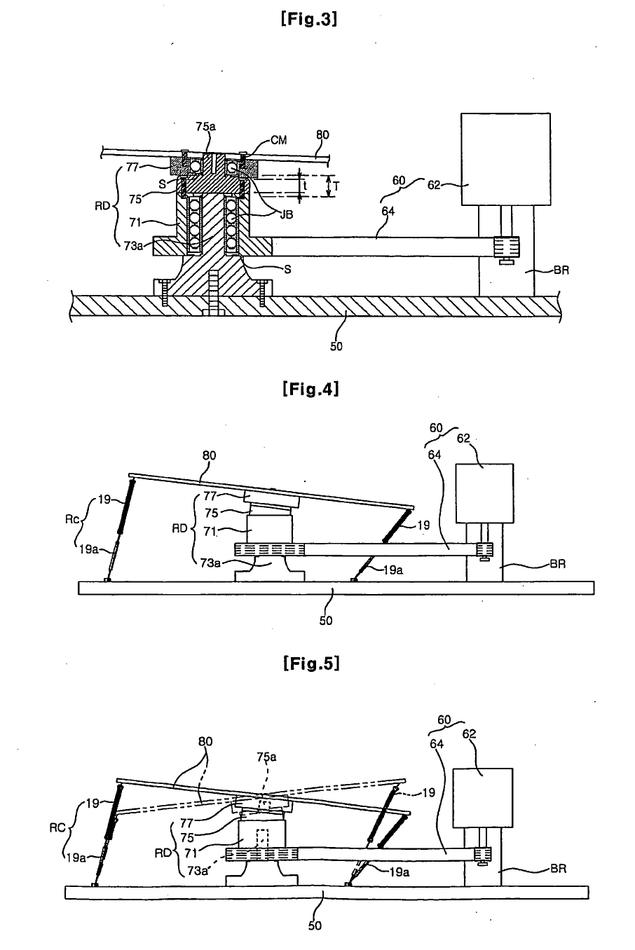

FIG. 1 is a perspective view of a sporting apparatus according to a first embodiment of the present invention, FIG. 2 is an exploded perspective view showing components of the sporting apparatus in FIG. 1 that provide undulating movement, FIG. 3 is a sectional side view showing the components in FIG. 2 in an assembled state, FIG. 4 is a side view showing the components in FIG. 2 before operation, and FIG. 5 is a side view showing the components in FIG. 2 during operation.

Referring to FIG. 1, a sporting apparatus for burning fat and strengthening muscles according to the first embodiment of the present invention includes a floorboard 80 installed in an exposed state on a base 14. The floorboard 80 undulates 3-dimensionally to provide 3-dimensional vibrating movement to a user that stands thereon.

Here, the base 14 is formed in a box form as shown, which contains a base frame 50, a drive unit 60, and an undulator RD, shown in FIG. 2. The base 14 also includes an opening and closing door 18 as shown in FIG. 1, providing access for examining or repairing the drive unit 60 and the undulator RD. Here, the drive unit 60 is a component for providing driving force to the undulator RD in order to operate the latter. In turn, the undulator RD is a component that undulates the floorboard 80. That is, the drive unit 60 and the undulator RD provide undulating movement to the floorboard 80.

A post 14a, to which a handle 14b for a user to grasp is connected, is installed on the base 14. Here, a control panel 14c, for controlling the on/off state and the speed of the drive unit 60, is installed on the post 14a. Also, a remote control R, for remotely controlling a portion of the functions controlled by the control panel 14c, is installed on the 14b. That is, a user operating the undulating action of the exercise machine can use the control panel 14c or the remote control R to control the operation of the drive unit 60. Of course, by controlling the operation of the drive unit 60 through the control panel 14c or the remote control R, the undulating movement of the floorboard is controlled.

Also, a stationary platform SP may be provided on the base 14. The stationary platform SP may be provided on either side of the floorboard 80. This stationary platform SP is for a user to use before exercising on the undulating floorboard 80 or during exercise. That is, the stationary platform SP is for a user to stand on before the operation of the floorboard 80 or during its operation. Accordingly, the user can stand on the stationary support SP when preparing to exercise or step off the floorboard 80 onto the stationary support SP while exercising.

Referring to FIG. 2, the base frame 50 is formed to be substantially horizontal in order to rest on a floor. The drive unit 60 and the undulator RD providing undulating movement to the floorboard 80 are installed on the base frame 50. The floorboard 80 is connected to the undulator RD. Here, a more detailed description of these components will be provided.

First, the base frame 50 may be formed from board material, as shown in FIG. 2, or pipe material that is interconnected (as shown in FIG. 10). Such a base frame 50 may be formed of a metal board or pipe material in order to sturdily support the drive unit 60 and the undulator RD.

Next, the drive unit 60 may include a motor 62 installed on the base from 50 and a drive belt 64 wound around the drive shaft of the drive motor 62 and a rotating drum 71 of the undulator RD. Thus, the motor 62 may use a bracket BR to be installed in suspension above the base frame 50. Also, the motor 62 may be a reversible motor capable of operating in forward and reverse directions or a step motor that is easy to control.

The belt 64 may have grooves 64a formed along its inner surface. When grooves 64a are formed in the inside of the belt 64, grooves 62a and 71a may be respectively formed on the outer surfaces of the drive shaft of the motor 62 and the rotating drum 71 to match the grooves 64a of the belt. Therefore, due to the engagement of the grooves 64a of the belt 64 to the grooves 62a and 71a of the motor shaft and rotating drum, the driving force of the motor is more effectively transferred. Such a belt 64 is a transferring member for transferring the driving force of the motor 62 to the undulator RD.

Here, the drive unit may alternatively employ gears (not shown). When gears are used in the drive unit, a driving gear must be installed on the drive shaft of the motor 62. Also, a driven gear that engages with the driving gear must be provided on the rotating drum 71. A drive unit employing this system of gears is well known to those skilled in the art, and a detailed description thereof will therefore not be given.

Next, the undulator RD may include the rotating drum 71, a rolling disk 75, and an undulating drum 77 stacked in sequence on the base frame 50. Here, the rotating drum 71 is fixed by means of a fixing member to be capable of rotation on the base frame 50. The rolling disk 75 is bolted integrally to the rotating drum 71. Also, the undulating drum 77 is supported through a supporting member on the rolling disk 75. Specifically, the rolling disk 75 forms the same body with the rotating drum 71. The undulating drum 77 does not form the same body with the rolling disk 75.

Here, the fixing member may include a through shaft 73a provided on the base frame 50, and a supporting ledge S protruding out from the through shaft 73a. Here, the through shaft 73a is fixed to the base frame 50 through bolts (not shown). The bolts pass through the base frame 50 and may be fastened to the through shaft 73a, or, in the case where a flange FL is formed around the through shaft 73a, as shown in FIG. 2, the bolts pass through the flange FL and fasten it to the base frame 50. Thus, the through shaft 73a is firmly fastened to the base frame 50 through the bolts.

Also, the supporting member may include a disk shaft 75a formed integrally with the rolling disk 75, and a supporting ledge formed around the disk shaft 75a. Here, the disk shaft 75a is formed on the center of the rolling disk 75. This disk shaft 75a may be formed together with the rolling disk 75, or formed separately from the rolling disk 75 and fastened on the rolling disk 75 with bolts (not shown).

The rotating drum 71 may be formed in the shape of a barrel, or in a circular plate form (unlike that shown in FIG. 2). The rotating drum 71 is rotated by the driving force from the motor 62 relayed through the belt 64. The rotating drum 71 thus has a through hole 71b formed therein for the through shaft 73a to pass through. That is, the through shaft 73a is inserted in the through hole 71b. Accordingly, the rotating drum 71 is inserted around the through shaft 73a, and the rotating drum 71 does not disengage from the through shaft 73a when rotating.

The rolling disk 75 may be formed separately to the rotating drum 71 and then bolted integrally to the rotating drum 71, or may be formed integrally with the rotating drum 71 when the latter is formed. The rolling disk 75 is integrated with the rotating drum 71 to rotate together with the rotating drum 71.

Therefore, the rolling disk 75 has a thickness difference of T and t, as shown in the enlarged view thereof in FIG. 2. Accordingly, the rolling disk 75 rotates in concert with the rotating drum 71 in a circular motion and forms a three-dimensional undulating motion in all directions. That is, the rolling disk 75 is a circular plate cam that changes rotating motion to an undulating motion.

The thicknesses (T and t) of the rolling disk 75 may be proportioned so that the thinner thickness t is ⅔ to ¾ of the thicker thickness T. For example, if the thickness difference ratio between T and t is greater than ⅔, the undulating range of the footboard 80 during its operation will be excessive and therefore unsuitable for people other than athletes and those who are proficient in exercise at fitness clubs, etc. Thus, the excessive undulation may cause muscle and joint problems in most users. On the other hand, when the thickness difference ratio between T and t is less than ¾, the exercising effects may be negligible due to an insufficient undulating range of the floorboard 80.

The undulating drum 77 may be formed in the shape of a drum, as shown, and may alternatively be formed in a discoid shape. The undulating drum 77 includes a through hole 77b through which the disk shaft 75a of the rolling disk 75 passes. That is, the disk shaft 75a is inserted into the through hole 77b. Therefore, the undulating drum 77 is inserted over the disk shaft 75a and mounted on the rolling disk 75. Thus, when the rolling disk 75 rotates, the undulating drum 77 undulates on the rolling disk 75. That is, the undulating drum 77 does not rotate together with the rolling disk 75, but only undulates.

Here, the undulating drum 77 undulates three-dimensionally by means of the rolling disk 75. That is, the undulating drum 77 undulates upward along a circular direction. The thus undulating drum 77 does not disengage from the rolling disk 75 through the disk shaft 75a inserted in the through-hole 77b.

The floorboard 80 is formed for a user to mount, and is fixed on the undulating drum 77 by means of through-type fastening members CM. Thus, the floorboard 80 is connected to the undulator RD through the fastening members CM. Here, the fastening members CM may be bolts as shown. The floorboard 80 thus connected to the undulator RD undulates three-dimensionally by means of the three-dimensionally undulating drum 77, and provides undulating movement to a mounted user.

The floorboard 80 may include a sealing member 80a installed thereon, as shown in FIG. 2. This sealing member 80a may be formed vertically along the edges of the plate of the floorboard 80. Also, the sealing member 80a should be made of an elastic material or a material that is corrugated as shown in FIG. 2 to provided elasticity. Such a sealing member 80a installed on the edges of the floorboard 80 seals the edges of the floorboard 80 to prevent bodily parts of a user from coming in contact with the undulator RD below the floorboard 80. Therefore, injury of the user is prevented by the sealing member 80a.

Undulation of the floorboard 80 is limited through an undulation limiter RC. This undulation limiter RC may include an elastic member 19 fixed to the base plate 50 and connected to the floorboard 80. Here, the elastic member 19 may be a coil spring, as shown in FIG. 2, and may be fixed to the base frame 50 through a stick-shaped fixing rod 19a fixed on the base frame 50. When the elastic member 19 is fixed to the base frame 50 through the fixing rod 19a, the length of the elastic member 19 is reduced. Thus, the elastic member 19 is adjustable in its elasticity according to the reduction in its length. That is, the fixing rod 19a is provided to adjust the elasticity of the elastic member 19.

The elastic member 19 may be provided in plurality, and may especially be provided on either side of the base frame 50 in mutual opposition. When the elastic members 19 are thus provided on either side of the base frame 50, the elastic members 19 are connected to either side of the floorboard 80.

Referring to FIG. 3, the undulator RD is installed on the base frame 50 according to the insertion of the rotating drum 71 over the through shaft 73a. Here, the rotating drum 71 of the undulator RD, the rolling disk 75, and the undulating drum 77 are vertically aligned over the base frame 50. The floorboard 80 is horizontally fixed on the undulating drum 77 through the fastening member CM, and an incline is formed by means of the rolling disk 75 having a difference in thicknesses T and t.

The rotating drum 71 is inserted at its center over the through shaft 73a, and has its outer circumference wound with the belt 64 of the drive unit 60 having the motor 62. Accordingly, the rolling disk 75 is bolted and fixed to the rotating drum 71 to rotate integrally with the rotating drum 71. Thus, the rolling disk 75 is installed on the base frame 50 to rotate by means of the motor 62. Also, the undulating drum 77 is mounted on the rolling disk 75 to support the floorboard 80. Therefore, the undulating drum 77 is installed on the base frame 50 to be capable of three-dimensional undulation.

Here, the supporting ledge S of the through shaft 73a supports the lower portion of the rotating drum 71. Also, the supporting ledge S of the disk shaft 75a supports the lower portion of the undulating drum 77. Accordingly, the rotating drum 71 does not contact the base frame 50. Also, the undulating drum 77 does not contact the rolling disk 75.

This through shaft 73a and disk shaft 75a may be inserted in a journal bearing JB, as shown in FIG. 3. The journal bearing JR prevents the inner surfaces of the rotating drum 71 and the undulating drum 77 from rubbing against the outer surfaces of the through shaft 73a and the disk shaft 75a. The journal bearing JR may use ball bearings.

Referring to FIG. 4, the elastic member 19 fixed to the base frame 50 through the fixing rod 19a is fixed to the bottom of the floorboard 80 to elastically connect the floorboard 80 to the base frame 50. This elastic member 19 is elastically connected at either side of the floorboard 80. Here, the elastic members 19 fastened at either end of the floorboard 80 are respectively elongated or contracted according to the incline formed by the rolling disk 75. That is, the elastic member 19 fixed at one side of the floorboard 80 is elongated, and the elastic member 19 fixed at the other side of the floorboard 80 is contracted.

The belt 64 of the drive unit 60 is wound around the rotating drum 71 of the undulator RD around the sides of the elastic member 19. That is, the belt 64 does not contact the elastic members 19.

Referring to FIG. 5, when the elastic member 19 undulates according to the solid line and the broken line signifying the floorboard 80, it expands and contracts repeatedly to dame the undulation of the floorboard 80. Here, when the floorboard 80 rises, the elastic member on that side expands to pull the floorboard 80 with its innate tension. When the floorboard descends, the elastic member 19 on that side contracts to allow the descending of the floorboard 80. Thus, undulation of the floorboard 80 is reduced through damping. Therefore, the undulation of the floorboard 80 is limited by the elasticity of the elastic members 19.

The above-structured exercise machine for burning body fat and strengthening muscles according to embodiments of the present invention will now be described in its operation, with reference to FIG. 5.

As shown in FIG. 5, the motor 62 of the drive unit 60 supported by the bracket BR drives the belt 64 around. Accordingly, the rotating drum 71 of the undulator RD having the belt 64 wound around it is rotated about the through shaft 73a. Here, the rolling disk 75 that is bolted and fixed to the rotating drum 71 rotates in concert to undulate three-dimensionally according to the different thicknesses T and t of the rolling disk 75. Thus, the undulating drum 77 mounted on the rolling disk 75 undulates by means of the rolling disk 75 undulation while inserted over the disk shaft 75a. Of course, the undulating drum 77 undulates 3-dimensionally along a circular direction according to the 3-dimensional undulation provided by the rolling disk 75.

The floorboard 80 integrally fixed to the undulating drum 77 undulates together with the undulating drum 77. Here, the floorboard 80 undulates 3-dimensionally according to the 3-dimensional undulating of the undulating drum 77. That is, the floorboard 80 undulates in all direction through the undulation of the undulating drum 77. Accordingly, the floorboard 80 provides three-dimensional undulating movement to a user mounted thereon.

As the floorboard 80 undulates in all directions to provide 3-dimensional undulating movement, a mounted user is exercised through having to move in order to maintain bodily equilibrium on the floorboard 80. Therefore, body fat is burned and muscles are strengthened in the user through the physical exercise obtained from the 3-dimensionally moving floorboard 80. The user especially uses the calves, thighs, buttocks, abdomen, waist, chest, back, and other bodily areas during exercise to strengthen muscles in the entire body.

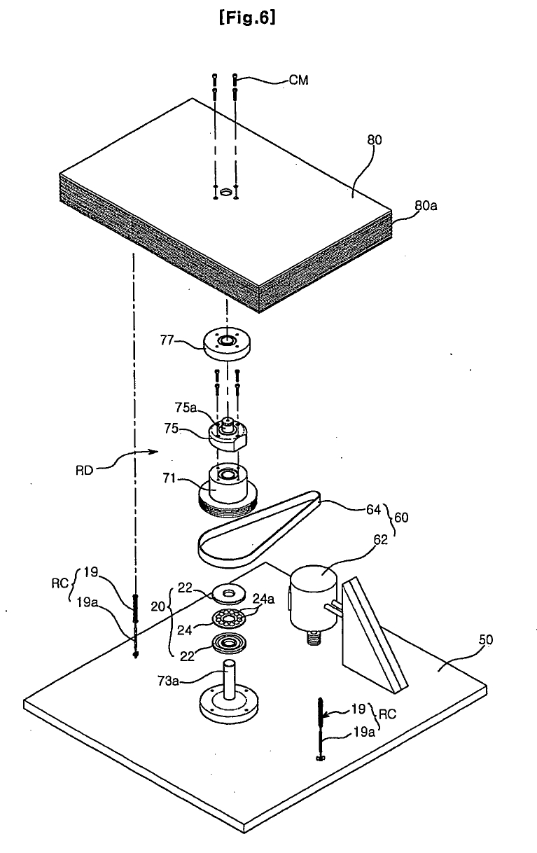

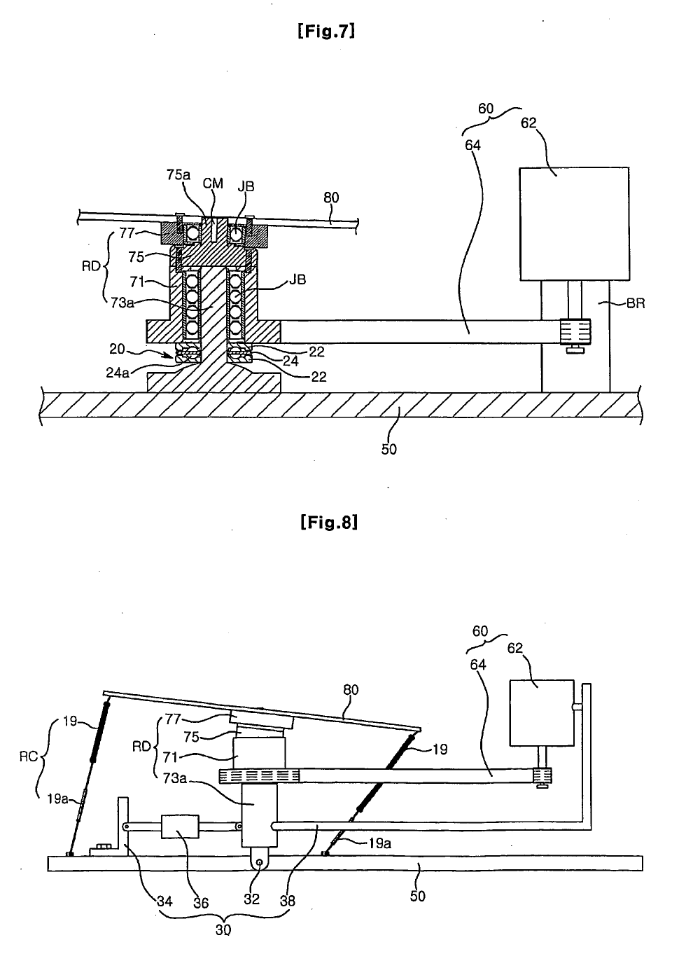

FIG. 6 is an exploded perspective view showing the components in FIG. 2 according to a second embodiment of the present invention, and FIG. 7 is a sectional side view showing the components in FIG. 6 in an assembled state. That is, FIGS. 6 and 7 show components of an exercise machine for providing undulating movement according to the second embodiment of the present invention. Components according to the second embodiment differ from the previous embodiment in that a foot bearing 20 is installed. Therefore, this difference will be described with reference to the diagrams.

Referring to FIG. 6, the foot bearing 20 includes a bearing plate 24 in which bearing members 24a formed to be rollable or slidable are inserted, and a housing 22 for enclosing the bearing plate 24. Here, the bearing members 24a may be balls, which may be arranged circumferentially in the bearing plate 24, as shown in FIG. 6. The housing 22 may be separately formed to enclose the top and bottom of the bearing plate 24 respectively. Such a foot bearing 20 is inserted over the through shaft 73a and disposed at the lower portion of the through shaft 73a.

Referring to FIG. 7, the separately formed housing 22 of the foot bearing 20 is open at the side through which the bearing members 24a are inserted into the bearing plate 24. That is, the pieces of the separately formed housing 22 do not contact each other on account of the thickness of the bearing members 24a. Therefore, the bearing members 24a are able to roll or slide within the housing 22.

This foot bearing 20 has a diameter capable of supporting the rotating drum 71 of the undulator RD. Also, the foot bearing 20 is inserted in the lower portion of the through shaft 73a and disposed at the lower portion of the rotating drum 71. Therefore, the foot bearing 20 supports the lower portion of the rotating drum 71. Accordingly, when the rotating drum 71 is rotated by the drive unit 60, the rotating drum 71 easily rotates by means of the foot bearing 20.

When the foot bearing 20 thus supports the rotating drum 71, the supporting ledge S of the through shaft 73a described with reference to FIG. 2 may be omitted. That is, the through shaft 73a does not need the supporting ledge S because the foot bearing 20 supports the rotating drum 71.

FIG. 8 is a side view showing the components in FIG. 2 according to the third embodiment of the present invention. That is, FIG. 8 shows components of an exercise machine providing undulating movement according to the third embodiment of the present invention. The difference in the third embodiment is the addition of an incline unit 30 providing an angle of incline to the through shaft 73a and drive unit 60. Therefore, only the added incline unit 30 will be described with reference to FIG. 8.

As shown in FIG. 8, in the third embodiment, an incline unit 30 is connected to the through shaft 73a and the drive unit 60. This incline unit 30 may include a hinge 32, a vertical bracket 34, a cylinder 36, and a link bracket 38. Here, a more detailed description of these components of the incline unit 30 will be provided.

First, the hinge 32 passes through the through shaft 73a and is fastened to the base frame 50, and fixes the lower end of the through shaft 73a to the base frame 50. Therefore, the through shaft 73a is able to pivot about the axis about the hinge 32 on the base frame 50.

Next, the vertical bracket 34 is separated from the through shaft 73a and is installed vertically on the base frame 50. The distance by which the vertical bracket 34 is separated is determined according to the length of the cylinder 36 and its stroke.

Next, the cylinder 36 is fixed at both ends by hinges to the vertical bracket 34 and the through shaft 73a. That is, the cylinder 36 is fixed to the vertical bracket 34 and the through shaft 73a at an end of a length adjustable rod and an end of a receiver in which the rod is enclosed, respectively. This cylinder 36, by being fixed at hinges on either end thereof to the vertical bracket 34 and the through shaft 73a, forms a shaft in a direction divergent to the through shaft 73a.

Moreover, the link bracket 38 is bent. The each end of the link bracket 38 is linked respectively to the through shaft 73a and the motor 62 of the drive unit 60, forming an integral link between the through shaft 73a and the motor 62.

The thus structured incline unit 30 is contracted by contracting the cylinder 36 that is controlled by the control panel 14c (in FIG. 1). Here, the cylinder 36 moves the through shaft 73a in a supported state through a rod that is contracted. Therefore, the through shaft 73a pivots about the hinge 32. Consequently, the link bracket 38 and the motor 62 pivot together with the through shaft 73a about the through shaft 73a. Of course, the undulator RD also pivots about the through shaft 73a by means of the through shaft 73a.

When the undulator RD thus pivots, the 3-dimensionally-moving floorboard 80 installed on the undulator RD pivots about the through shaft 73a together with the undulator RD. Therefore, the floorboard 80 may be adjusted with respect to its degree of inclination. That is, the floorboard 80 undulates 3-dimensionally after its angle of inclination has been adjusted. Accordingly, the floorboard 80 can provide an undulation workout of increased intensity to a user standing thereon. Of course, the user can derive a more effective fat burning and muscle strengthening workout as a result.

This floorboard 80 may be repeatedly pivoted through the cylinder 36. That is, the cylinder 36 may repeatedly be contracted. As such, a user can gain not only undulating exercise, but also exercise comparable to surfing. Specifically, the incline unit 30 can provide a user with surfing-type exercise.

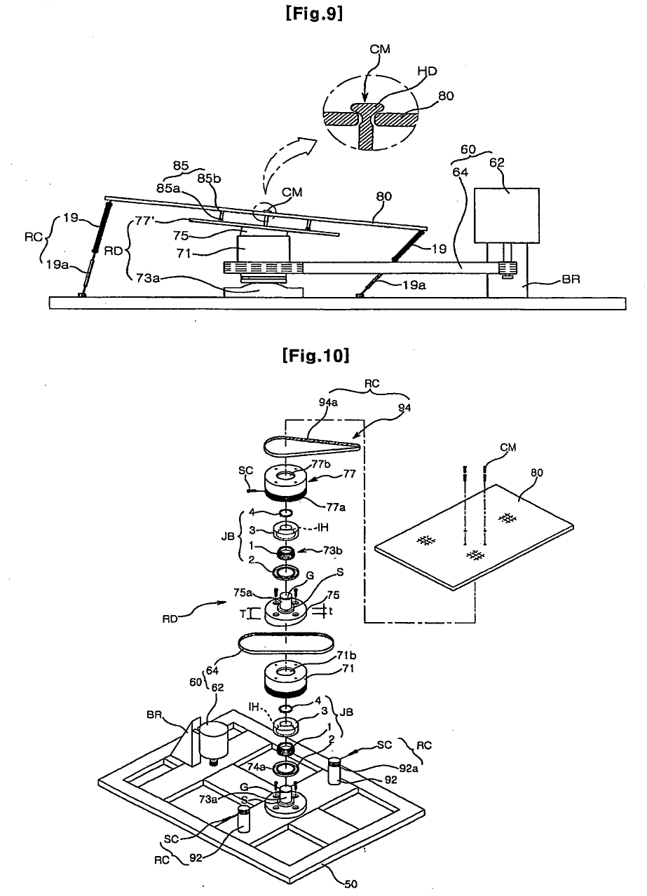

FIG. 9 is a side view showing the components in FIG. 2 according to the fourth embodiment of the present invention. That is, FIG. 9 shows the components of an exercise apparatus providing undulating movement according to the fourth embodiment of the present invention. The components according to the fourth embodiment omit the above-described disk shaft 75a from the rolling disk 75 of the undulator RD, add an undulating drum 77′ formed in a plate shape, and add a roller member 85 on the undulating drum 77′.

In the fourth embodiment, a plate shaped undulating drum 77′ is mounted on the rolling disk 75 of the undulator. RD that does not have the above-described disk shaft 75a. Also, the roller member 85 is mounted on the plate shaped undulating drum 77′ to support the floorboard 80. Here, the floorboard 80, as shown in the enlarged view, is fastened to the rolling disk 75 by means of a fastening member CM passing through the floorboard and anchoring the floorboard 80 with the head HD of the fastening member CM. Thus, the floorboard 80 is connected to the rolling disk 75 through the fastening member CM. Of course, the fastening member CM is passed through the floorboard 80 and the undulating drum 77′ in sequence and fastened to the rolling disk 75.

Here, the roller member 85 may include a roller 85a attached to the undulating drum 77′, and a roller rod 85b fixed to the lower portion of the floorboard 80 to allow the roller 85a to pivot.

In the thus structured fourth embodiment, the plate shaped undulating drum 77′ of the undulator RD undulates 3-dimensionally, according to the pivoting of the rolling disk 75 together with the rotating drum 71. Here, the roller 85a rolls on the plate shaped rolling drum 77′ to support the floorboard 80 through the roller rod 85b. Of course, the floorboard 80 moves 3-dimensionally by means of the plate shaped undulating drum 77′, due to the floorboard 80 being supported to undulate on the undulating drum 77′ by the roller rod 85n through the roller 85a. Accordingly, the floorboard 80 provides undulating exercise to burn fat and strengthen muscles for a user mounted thereon.

Here, as described in the fourth embodiment, the roller 85a may be formed on the rolling disk 75 in direct contact therewith. Also, the roller member 85 may be installed on the lower portion of the floorboard 80 circularly around the rolling disk 75, to contact the roller member 85 on the rolling disk 75.

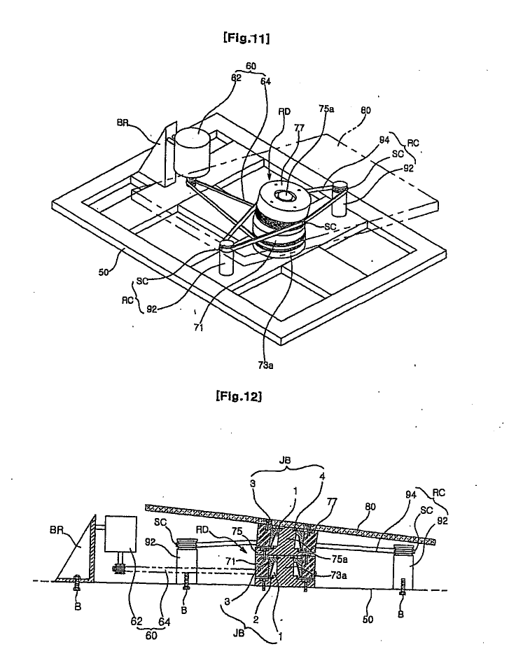

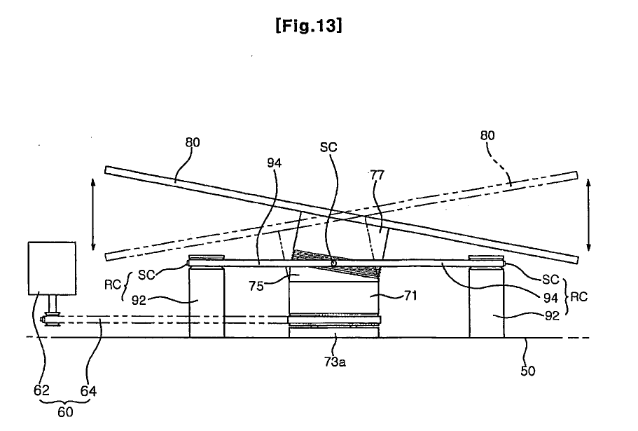

FIG. 10 is an exploded perspective view showing the components in FIG. 2 according to the fifth embodiment of the present invention, FIG. 11 is a perspective view showing the components in FIG. 10 in an assembled state, FIG. 12 is a sectional side view showing the components in FIG. 10 in an assembled state, and FIG. 13 is a side view showing the components in FIG. 10 during operation. That is, FIGS. 10 through 13 show components of an exercise machine for providing undulating movement, according to the fifth embodiment of the present invention. The differences between the fifth embodiment of the present invention and the previous embodiments include the addition of a needle-type journal bearing JR installed on the above-described through shaft 73a and disk shaft 75a of the undulator RD, and an undulation limiter RC. Accordingly, these differences will be described with reference to the drawings.

Referring to FIG. 10, the needle bearing JR installed on the through shaft 73a and disk shaft 75a of the undulator RD may include, as shown in FIG. 10, a needle bearing 1, and an upper cap and a lower cap 2 and 3 respectively enclosing the upper and lower portions of the needle bearing 1, a snap ring 4 fitted over the through shaft 73a and disk shaft 75a to support the upper cap 2, and a fixing member fixing the snap ring 4 to the through shaft 73a and disk shaft 75a. Here, a more detailed description of the journal bearing JR will be provided.

First, the journal bearing 1 is tapered on its outer surface to support a compound load of the floorboard 80 applied to the needle bearing 1 and to allow self-aligning.

That is, the needle bearing 1 is a self-aligning tapered needle bearing.

Next, the upper cap 2 encloses the upper portion of the needle bearing 1. The upper cap 2 has a through-hole IH that formed by an inner surface thereof with a taper for enclosing the tapered needle bearing 1. Thus, the upper cap 2 can securely support the outer surface of the needle bearing 1. The upper cap 2 may operate as the rim of the needle bearing 1. That is the upper cap 2 may rotate around the outer perimeter of the needle bearing 1.

Next, the lower cap 3 is coupled to the upper cap 2 and supports the lower portion of the needle bearing 1. Accordingly, the lower cap 3 seals and protects the needle bearing 1 together with the upper cap 2.

Also, the snap ring 4 is inserted on the through shaft 73a and the disk shaft 75a by means of a fixing member, to prevent the upper cap 2 from dislodging in an upward direction.

The fixing member may be a ring groove G formed in the through shaft 73a and the disk shaft 75a, as illustrated in FIG. 10. This ring groove G confines the snap ring 4 inserted in the through-shaft 73a and disk shaft 75a, preventing the snap ring 4 from moving along the direction of the through shaft 73a and the disk shaft 75a. That is, the snap ring 4 is inserted into the ring groove G.

The undulation limiter RC in the fifth embodiment may include at least one vertical shaft 92 bolted on the base frame 50, and an elastic connecting belt 94 made of a material such as rubber or urethane and coupled to the vertical shaft 92.

Here, a plurality of the vertical shafts 92 may be used. For example, as shown in FIG. 11, two vertical shafts 92 may be oppositely installed on either side of the base frame 50 with the undulating drum 77 of the undulator RD in the middle.

Also, the connecting belt 94 may be formed in a ring shape and fixed by fixing screws SC to the vertical shafts 92 and the undulating drum 77 of the undulator RD. This connecting belt 94, like the belt 64 described above, includes a ridge formed in its inner surface. Of course, the outer surface of the undulating drum 77 forms a ridge groove 77a for receiving the ridge. Here, the ridge 94 and the ridge groove 77a are like the grooves 71a formed on the belt 64 and the rotating drum 71.

Referring to FIG. 11, the vertical shaft 92 of the undulation limiter RC is installed on the base frame 50 separated from the undulating drum 77 of the undulator RD. That is, the vertical shaft 92 maintains a distance from the undulator RD.

Also, the connecting belt 94 of the undulation limiter RC is wound in a taut state around the vertical shaft 92 and the undulating drum 77 of the undulator RD, and is fixed at one side and a central portion thereof to the undulating drum 77 and the vertical shaft 92 by means of the fixing screws SC. That is, the fixing screws SC pass through the connecting belt 94 and fasten respectively to the vertical shaft 92 and the undulating drum 77. Accordingly, the connecting belt 94 is connected to the vertical shaft 92 and the undulator RD through the fixing screws SC.

Referring to FIG. 12, the needle bearing of the journal bearing JR is sealed and supported by the upper cap 2 and the lower cap 3, to rotatably support the inner surface of the rotating drum 71 and the undulating drum 77. Therefore, the rotating drum 71 and the undulating drum 77 rotate smoothly while performing undulation, due to the journal bearing JR.

Here, the upper cap 2 of the journal bearing JR is supported at its upper portion by the snap ring 4 inserted in the upper ends of the through shaft 73a and disk shaft 75a. Thus, the needle-type journal bearing JR does not dislodge from the through shaft 73a and the disk shaft 75a when the rotating drum 71 and the undulating drum 77 rotate and undulate.

The vertical shaft 92 of the undulation limiter RC is fastened by a bolt B passing through the base frame 50 and fixed on the base frame 50. Also, the connecting belt 94 of the undulating limiter RC has one end fixed to the vertical shaft 92, to provide elastic support in lateral directions to the undulating drum 77. That is, the connecting belt 94 elastically supports the undulating drum 77 in lateral directions.

Referring to FIG. 13, when the undulating drum 77 of the undulator RC undulates 3-dimensionally to 3-dimensionally undulate the floorboard 80, the connecting belt 94 that maintains tautness uses elasticity to limit excessive undulation of the undulating drum 77. That is, the undulating drum 77 is prevented by the elasticity of the connecting belt 94 from excessively undulating. Here, the undulating drum 77 is damped in its undulation by the elasticity of the connecting belt 94. Accordingly, the floorboard 80 connected to the undulating drum 77 is limited in its undulation. Of course, the connecting belt 94, due to its material, does not generate noise.

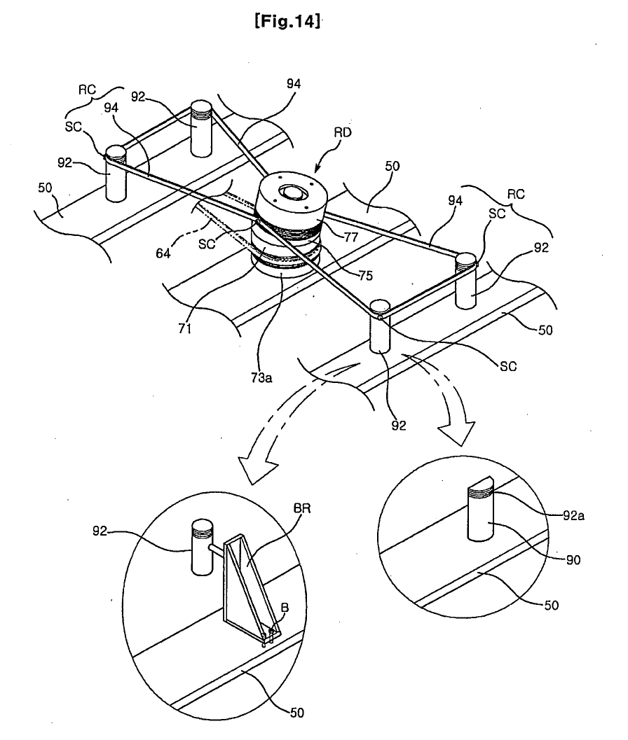

FIG. 14 is a perspective view showing the components in FIG. 2 according to the sixth embodiment of the present invention. That is, FIG. 14 shows the components of an exercise machine for providing undulating exercise, according to the sixth embodiment of the present invention. The sixth embodiment differs from the fifth embodiment in that there are a number of vertical shafts 92 provided. The resulting difference will be described with reference to FIG. 14.

As shown, the vertical shaft 92 of the undulation limiter RC is provided in four opposing positions with respect to the undulating drum 77 of the undulator RD. These vertical shafts 92 may be provided in quadruplicate, with two at the front and two at the rear of the undulating drum 77. Of course, the connecting belt 94 is formed in a quadrangular closed loop shape and wound around the four vertical shaft 92. This quadrangular connecting belt 94 has a higher elasticity due to being stretched by the four vertical shafts 92. Accordingly, the connecting belt 94 is able to limit the undulation of the undulating drum 77 more firmly with its increased innate elasticity. Of course, the undulation of the floorboard 80 is limited according to the limiting of the undulating drum's 77 undulation.

Here, the bracket BR enlarged in the lower left image of FIG. 14 is shown fixing the vertical shaft 92. That is, the vertical shaft 92 may be fixed on the base frame 50 through the bracket BR. Also, as shown in the lower right image of FIG. 14, the enlarged vertical shaft 92 is formed as half a cylinder. That is, the vertical shaft 92 may be a semi-cylindrical metal pipe. Of course, the vertical shaft 92 may be box-shaped or triangular. However, the vertical shaft 92 should be formed substantially perpendicular to the base frame 50 in order to wind the annular connecting belt 94 the therearound.

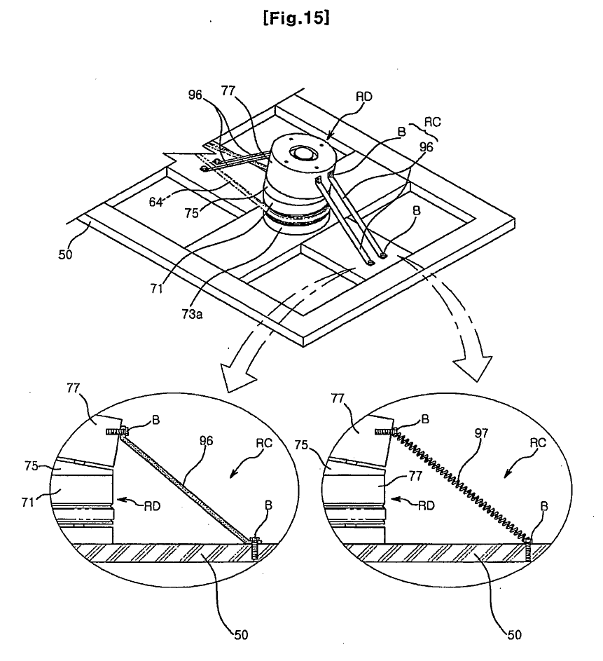

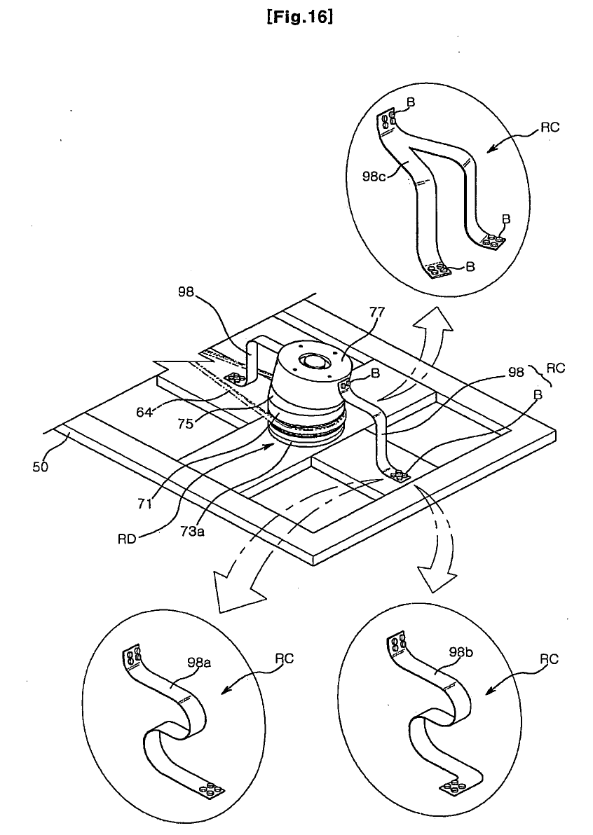

FIG. 15 is a perspective view showing the components in FIG. 2 according to the seventh embodiment of the present invention. That is, FIG. 15 shows the components of an exercise machine for providing undulating exercise, according to the seventh embodiment of the present invention. The difference between the seventh embodiment and previous embodiments lies in the undulation limiter RC being formed of rubber bands or coil springs. Therefore, this difference will be described with reference to FIG. 15.

As shown in FIG. 15, the undulation limiter RC according to the seventh embodiment is a connecting band 96 made of an elastic material that is connected at one end to the undulating drum 77 of the undulator RD and connected to the base frame 50 at the other end thereof to retain a taut state. Here, the connecting band 96 is formed in a straight line, as shown in the image in the lower left of FIG. 15, where it is straightened by bolts B fastening either end thereof to the undulating drum 77 and the base frame 50. Accordingly, the undulating range of the undulating drum 77 is limited by the elasticity of the connecting band 96. Of course, the undulating range of the floorboard 80 is limited according to the limiting of the undulating drum's 77 undulation.

Here, the connecting band 96 may be provided in quadruplicate facing the undulating drum as shown in FIG. 15, or be provided in duplicate on either side facing the undulating drum 77. That is, the connecting band 96 may be provided in quadruplicate as shown in FIG. 15, or in duplicate. Of course, the connecting band 96 may be provided singularly or in a number exceeding four.

Here, in the lower right image of FIG. 15, the coil band 96 is replaced with a coil-type spring 97. That is, the undulation limiter RC may be formed as a coil-type spring 97. In other words, the undulation limiter RC may be formed as a straight connecting band 96 or alternately, as a coil-type spring 97. This coil-type spring 97 limits the undulation of the undulating drum 77 through its innate elasticity. Of course, the undulation of the floorboard 80 is limited according to the undulation limiting of the undulating drum 77.

FIG. 16 is a perspective view showing the components in FIG. 2 according to the eighth embodiment of the present invention. That is, FIG. 16 shows the components of an exercise machine for providing undulating exercise, according to the eighth embodiment of the present invention. The eighth embodiment differs from the preceding embodiments in that the undulation limiter is formed as a plate spring. Therefore, the difference will be described with reference to FIG. 16.

As shown in FIG. 16, the undulation limiter RC according to the eighth embodiment of the present invention is formed as a plate-type spring 98. Here, the plate-type spring 98 may be bent in an ‘L’ shape (as shown in the top image in FIG. 16) to have elasticity, and may alternately be bent in an ‘S’ shape, as shown in the bottom images in FIG. 16. This plate-type spring 98 may be directly connected at either end thereof through bolts B to the undulating drum 77 of the undulator RD and the base frame 50. Accordingly, the plate-type spring 98 limits the undulation of the undulating drum 77 through its innate elasticity. Of course, the undulation of the floorboard 80 is limited according to the limited undulation of the undulating drum 77.

Here, the enlarged lower right image of an ‘S’ shaped plate-type spring fixed to the base frame 50, that is bent one further time. That is, the plate-type spring 98 may have its lower end bent once more.

Also, in the enlarged upper image in FIG. 16, the plate-type spring 98 may be formed in a branching shape of a wishbone, in order to reinforce its elasticity. That is, the plate-type spring 98 may branch in two from top to bottom, as shown in the enlarged upper image in FIG. 16.

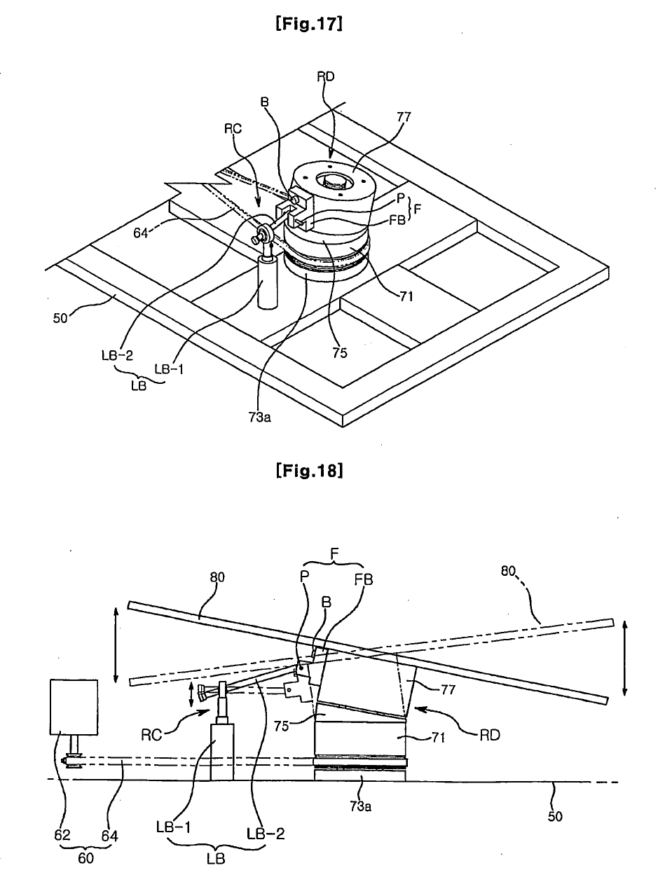

FIG. 17 is a perspective view showing the components in FIG. 2 according to the ninth embodiment of the present invention, FIG. 18 is a side view showing the components in FIG. 17 during operation. That is, FIGS. 17 and 18 show components of an exercise machine for providing undulating exercise according to the ninth embodiment of the present invention. The ninth embodiment differs from previous embodiments in that the undulation limiter RC is formed as a load bearing. Accordingly, the difference will be described with reference to the diagrams.

Referring to FIG. 17, the undulation limiter RC according to the ninth embodiment may include a load bearing LB having a ball joint with a fixing portion LB-1 installed vertically on the base frame 50 and a moving portion LB-2 connected perpendicularly to and moving about an end of the fixing portion LB-1, and a fixing member F for fixing the moving portion LB-2 of the load bearing LB to the undulating drum 77 of the undulator RD.

Here, the fixing member F may be a structure including a fixing bracket FB fixed by bolts B to the outer surface of one end of the undulating drum 77, a connecting pin P passing through the fixing bracket FB and the other end of the moving portion LB-2 to connect the fixing bracket FB to the moving portion LB. Here, the other end of the moving portion LB-2 of the load bearing LB is able to move through the connecting pin P. That is, the other end of the moving portion LB-2 is able to pivot about the connecting pin P.

Referring to FIG. 18, the moving portion LB-2 of the load bearing LB moves through the undulation of the undulating drum 77. That is, the moving portion LB-2 moves in an oval shape through the undulation of the undulating drum 77. Here, the moving stroke of the moving portion LB-2 is restricted by the fixing portion LB-1 at one end thereof and the fixing pin P at the other end thereof. Accordingly, the load bearing limits the undulation of the undulating drum 77. Of course, the undulation of the floorboard 80 is limited according to the limited undulation of the undulating drum 77.

When the undulation limiter RC is thus formed with the load bearing LB and the fixing member F, the ridge groove 77a (FIG. 10) formed on the surface of the undulating drum 77 is omitted. That is, the undulation limiter RC depicted in FIGS. 17 and 18 does not use the connecting belt 94 (FIG. 10) with ridges 94a formed on its inner surface, so that the ridge grooves 77a can be omitted.

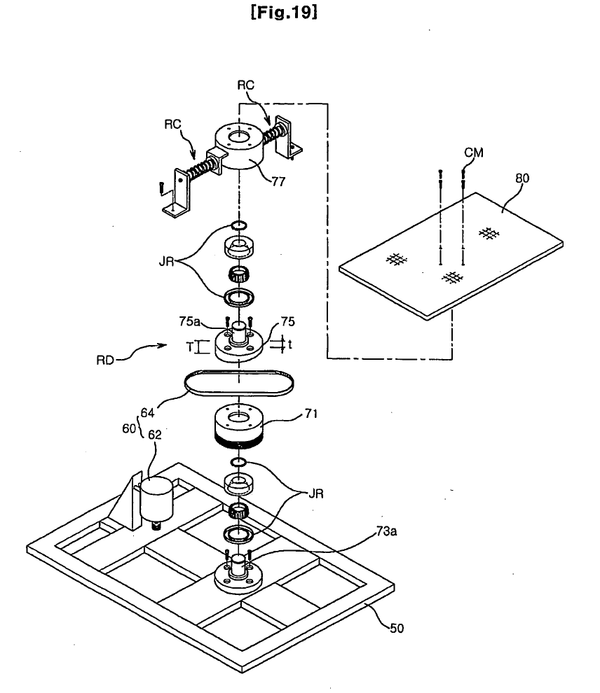

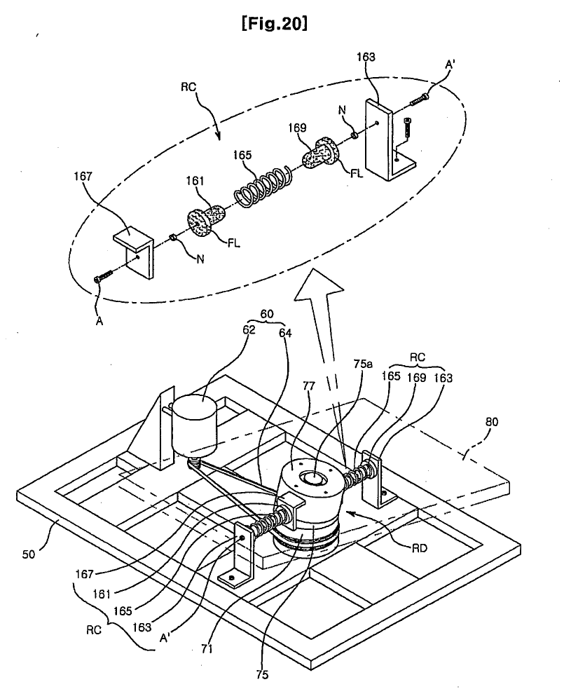

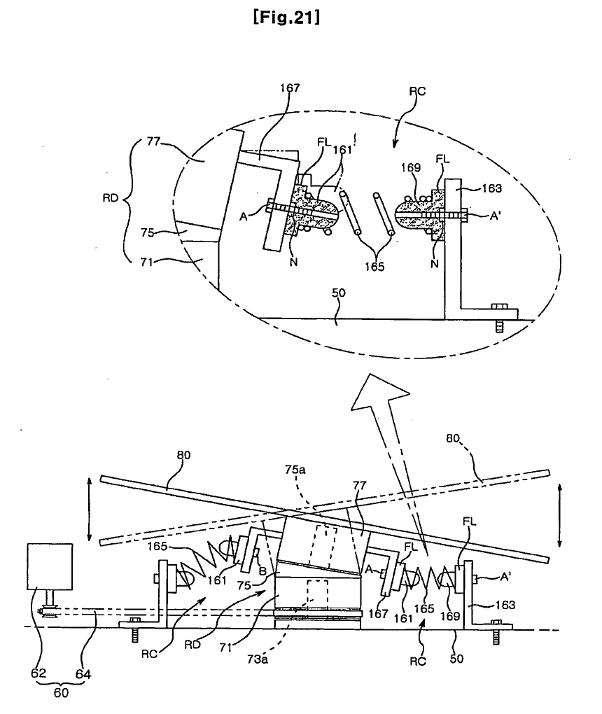

FIG. 19 is an exploded perspective view showing the components in FIG. 2 according to the tenth embodiment of the present invention, FIG. 20 is a perspective view showing the components in FIG. 19 in an assembled state, and FIG. 21 is a side view showing the components in FIG. 19 during operation. That is, FIGS. 19 through 21 show components of an exercise machine providing undulating exercise according to the tenth embodiment of the present invention. In the tenth embodiment, all components are the same as in the fifth embodiment (FIG. 10), except for the undulation limiter RC having a mounting angle 163 and a spring tube 165. Accordingly, this difference will be described with reference to the diagrams.

Referring to FIG. 19, the undulation limiter RC according to the tenth embodiment is integrally installed with the undulating drum 77 of the undulator RC that moves 3-dimensionally. One undulation limiter RC is respectively provided on either side of the undulating drum 77 to limit the undulation of the undulating drum 77 from either side of the undulating drum 77.

Referring to claim 20, the undulation limiter RC according to the tenth embodiment may include a mounting angle 163 fixed on the base frame 50 a distance apart from the undulating drum 77 of the undulator RD, and a spring tube 165 connected at either end thereof to the mounting angle 163 and the undulating drum 77.

Here, the ends of the spring tube 165 are respectively connected to the undulating drum 77 and the mounting angle 163, so that they are spaced a distance apart from the axis of the undulating drum 77. That is, one end of the spring tube 165 is connected to the undulating drum 77, and the other end is connected to the mounting angle 163. As shown, the spring tube 165 is substantially perpendicular to the undulating drum 165 and is disposed in a horizontal position. Accordingly, the spring tube 165 is interposed horizontally between the undulating drum 77 and the mounting angle 163.

The spring tube 165 may be formed of a metal coil spring that is welded at both ends to the outer surface of the undulating drum 77 and the mounting angle 163, respectively. However, the ends may be connected through a first end and second end connecting member to the undulating drum 77 and the mounting angle 163, as described below. That is, the above-described undulation limiter RC may further include a first end connecting member and a second end connecting member.

Here, the first end connecting member may include a bent angle bracket 167, a first inserting protrusion 161 circularly formed for inserting in the spring tube 165, and a coupling shaft A for coupling to the angle bracket 167.

Also, the second end connecting member may include a second inserting protrusion 169 formed the same as the first inserting protrusion 161, and a fixing shaft A′ fastened to the mounting angle 163.

Here, the coupling shaft A and the fixing shaft A′ may be screwed using a nut N. Also, a flange FL may be integrally formed on the ends of first and second inserting protrusions 161 and 169.

Referring to FIG. 21, the angle bracket 167 of the first end connecting member is directly connected to one side of the outer surface of the undulating drum 77, as shown in the enlarged diagram. Also, the coupling shaft A protrudes as it is fastened to the angle bracket 167. The first inserting protrusion 161 is inserted and fixed in the coupling shaft A. Thus, the first inserting protrusion 161 is connected to the undulating drum 77.

One end of the spring tube 165 is inserted in the first inserting protrusion 161 connected to the undulating drum 77. Accordingly, the spring tube 165 is connected to the undulating drum 77 through the first inserting protrusion 161.

Here, to describe the first end connecting member in more detail with reference to the diagrams, the angle bracket 167 has its middle portion bent at a right angle to form an ‘L’ shape. Thus, the angle bracket 167 has one side and the other side forming a horizontal and vertical direction. Here, the one side forming the horizontal direction is welded to the outer surface of the undulating drum 77.

Next, the one end of the spring tube 165 is inserted in the first inserting protrusion 161 the other side of the angle bracket 167 in a vertical direction. Here, the one end of the spring tube is supported on the flange FL formed on the end of the first inserting protrusion 161.

The first inserting protrusion 161 has an exterior corresponding to the inner surface of the spring tube 165. Accordingly, the first inserting protrusion 161 is inserted into the one end of the spring tube 165 and is supported circularly in it inner circumference. Accordingly, the spring tube 165 has an increased strength due to being supported by the first inserting protrusion 161. Of course, the spring tube 165, due to the first inserting protrusion 161 inserted into the one end thereof, is integrally connected to the outer surface of the undulating drum 77. That is, the spring tube 165 is connected to the outer surface of the undulating drum 77 due to the coupling of the first inserting protrusion 161 to the angle bracket 167.

Then, the coupling shaft A passes through the other side of the angle bracket 167 in a vertical direction and proceeds toward the first inserting protrusion 161. Accordingly, the coupling shaft A protrudes from a direction from the other end of the angle bracket 167 towards the axis of the undulating drum 77 to be spaced apart from the undulating drum 77. Here, the coupling shaft A may have a bolt, as shown in the enlarged image in FIG. 21.

This coupling shaft A is first fastened to the angle bracket 167 through the nut N, and passes through the center of the first inserting protrusion 161. That is, the coupling shaft A is screwed and fastened by means of the nut N to the angle bracket 167 and passes through the center of the first inserting protrusion 161. Accordingly, the coupling shaft A integrally couples the first inserting protrusion 161 to the angle bracket 167. That is, the coupling protrusion 161 is integrally coupled to the angle bracket 167 through the coupling shaft A. Of course, the spring tube 165 is connected at one end thereof to the angle bracket 167 through the first inserting protrusion 161.

The connecting member on the other end has a second inserting protrusion 169 inserted and fixed to the fixing shaft A′ fastened to the mounting angle 163. Thus, the second inserting protrusion 169 is integrally formed and fixed on the mounting angle 163. This second inserting protrusion 169 is inserted into the other end of the spring the 165. Accordingly, the spring tube 165 is connected to the mounting angle 163 through the second inserting protrusion 169.

Here, this other end connecting member will be described in further detail with reference to the diagrams. First, the second inserting protrusion 169 is inserted into the fixing shaft A′ fastened to the mounting angle 163. Also, the second inserting protrusion 169 is inserted in the other end of the spring tube 165 fixed to the fixing shaft A′. Here, the other end of the spring tube 165 is supported by the flange FL formed on the end of the second inserting protrusion 169. Accordingly, the spring tube 165 is connected to the mounting angle through the other end inserted in the second inserting protrusion 169.

Next, the fixing shaft A′ passes through the mounting angle 163 and protrudes in the direction of the axis of the undulating drum 77, spaced a distance from the axis. Here, the fixing shaft A′ may employ a bolt.

This fixing axis A′ is first fastened to the mounting angle 163 through the nut N, and passes through the center of the second inserting protrusion 169. That is, the fixing shaft A′ is screwed to the nut N to be fastened to the mounting angle 163, and passes through the center of the second inserting protrusion 169. Accordingly, the fixing shaft A′ fixes the second inserting protrusion 169 integrally to the mounting angle 163. That is, the second inserting protrusion 169 is integrally fixed to the mounting angle 163 through the fixing shaft A′. Of course, the spring shaft 165 is connected to the mounting angle 163 through the other end inserted in the second inserting protrusion 169.

The above-described first and second inserting protrusions 161 and 169 may be formed of metal or a rubber material for elastically supporting the spring shaft 165 after being inserted in the end of the spring shaft 165. Also, in order to support the first and second inserting protrusion 161 and 169 through the coupling shaft A and the fixing shaft A′, the coupling shaft A and the fixing shaft A′ may be extended in length.

Also, the above-described coupling shaft A and the fixing shaft A′ may be welded to the angle bracket 167 and mounting angle 163. When the coupling shaft A and the fixing shaft A′ are thus welded on the angle bracket 167 and the mounting angle 163, the nut N fixing the coupling shaft A and the fixing shaft A′ may be omitted.

Also, the above-described coupling shaft A may be directly welded to the outer surface of the undulating drum 77. Here, the head of the coupling shaft A is welded to the outer surface of the undulating drum 77. When the coupling shaft A and the undulating drum are thus directly connected, the above-described angle bracket 167 may be omitted. Of course, the fixing shaft A′ may be directly welded to the mounting angle 163. Here, the nut N fastened to the fixing shaft B may be omitted.

The one end of the above-described spring shaft 165 may be directly welded or bolted to the angle bracket 167. Here, the first inserting protrusion 161 and the coupling shaft A coupled to the angle bracket 167 may be omitted.

The operation of the undulation limiter RC according to the tenth embodiment will be described with reference to FIG. 21.

As shown, when the undulating drum 77 of the undulator RD undulates three-dimensionally to undulate the floorboard 80 3-dimensionally, the undulating of the undulating drum is damped through the innate elasticity of the spring tube 165. Here, the spring tube 165 provides elasticity to the undulating drum 77 in a right angle direction. Also, the spring tube 165, being formed in a tube-shape, provides elasticity in column-like manner. Accordingly, the spring tube 165 limits the undulating of the undulating drum 77 and provides a countering force to the undulating drum 77.

Accordingly, the undulating of the undulating drum 77 is reduced and damped by the elasticity provided by the spring tube 165. Therefore, the undulating range of the floorboard 80 is securely limited. That is, the floorboard 80 undulates smoothly by means of the spring tube 165.

When the undulating drum 77 undulates, this spring tube 165 is deformed into a curved shape. However, due to its innate strength and elasticity, it reassumes its original shape to damp the undulation of the undulating drum 77. Here, the first and second inserting protrusions 161 and 169 support both end portions of the spring tube 165, preventing dislodging thereof. In this way, the spring 165 repeatedly deforms in a curved shape and reassumes its original shape, while maintaining its connection with the angle bracket 167 and mounting angle 163. That is, although the spring tube 165 repeatedly deforms into a curved shape and reassumes its original shape, both ends thereof do not disengage from the angle bracket 167 and the mounting angle 163.

Also, the first and second inserting protrusions 161 and 169 support the inner surface of the end of the spring tube 165. Therefore, the spring tube 165 is strengthened so that excessive curved deformation thereof is prevented and also reassuming of its original shape is achieved in less time.

These first and second inserting protrusions 161 and 169 made of rubber that support the inner surface of the spring tube 165 are made of the same elastic material as the spring tube 165, to deform in curvature and reassume its original shape. Accordingly, even if the spring tube 165 is made stronger, not only is curved deformation easy, but reassuming of its original shape is easy also.

The first and second inserting protrusions 161 and 169 made of a rubber material absorbs frictional resistance when the spring tube 165 deforms in curvature and reassumes its original shape, due to the characteristics of the rubber material. Thus, the spring tube 165 can deform in curvature and reassume its original shape smoothly and silently. The end of the spring tube 165 is supported by the flange FL formed on the first and second inserting protrusions 161 and 169, so that deformation in curvature and reassuming of its original shape can be accomplished with even less noise and more smoothly.

The spring tube 165 is easily connected to the angle bracket 167 and the mounting angle 163 by inserting both ends thereof into the first and second inserting protrusions 161 and 169.

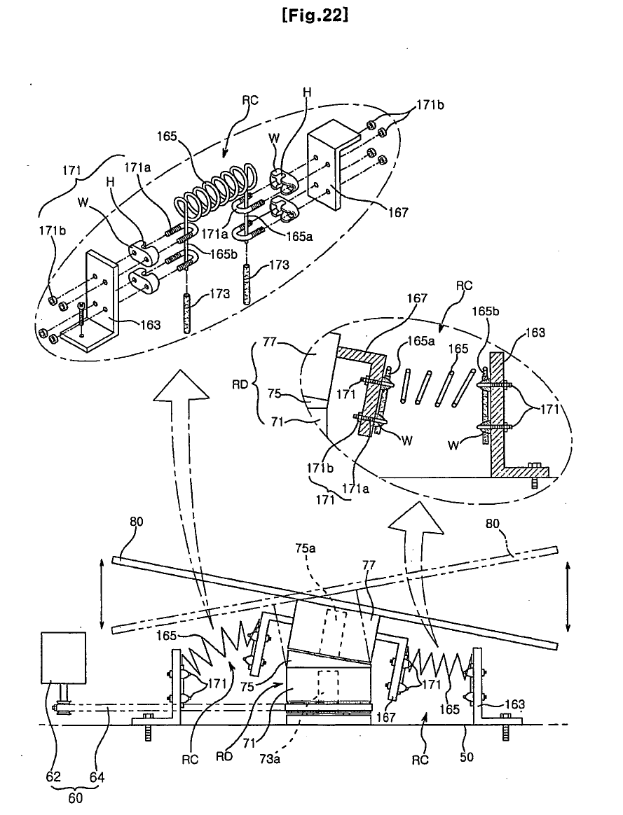

FIG. 22 is a side view showing the components in FIG. 2 according to the eleventh embodiment of the present invention. That is, FIG. 22 shows components of an exercise machine that provides undulating exercise, according to the eleventh embodiment of the present invention. All the components of the eleventh embodiment are the same as those of the tenth embodiment, except for the first and second end connecting members of the undulation limiter RC. Thus, this difference will be described with reference to FIG. 22. That is, a description of the first end and second end connecting members that are different from the tenth embodiment will be given.

As shown, the first end and second end connecting members of the undulation limiter RC according to the eleventh embodiment, as shown in the enlarged exploded perspective view at the top of FIG. 22, include end shafts 165a and 165b integrally formed at the respective ends of the spring tube 165, and a fastening member 171 for enclosing the end shafts 165a and 165b and fastening the spring tube 165 respectively to the mounting angle 163 and the angle bracket 167.

Here, the end shafts 165a and 165b are formed at either end of the spring tube 165 of the same body as the spring tube 165, and may be formed at a substantially right angle to an axial direction of the spring tube 165 as shown in the exploded perspective view in FIG. 22.

Also, the above-described fastening member 171 may include a ‘U’-shaped u-bolt 171a, and a nut 171b that is screwed to the u-bolt 171a. In this fastening member 171, the u-bolt 171a encloses the end shafts 165a and 165b spring tubes 165, and is screwed together with the nut 171b after passing through the angle bracket 167 and the mounting angle 163. Accordingly, the u-bolt 171a is fastened to the angle bracket 167 and mounting angle 163.

Here, the spring tube 165, as shown in the enlarged sectional view in the middle of FIG. 22, has its end shafts 165a and 165b connected to the angle bracket 167 and mounting angle 163 through the u-bolt 171a. That is, the spring tube 165 is fixed to the angle bracket 167 and mounting angle 163 through the u-bolt 171a that encloses the end shafts 165a and 165b. Thus, when the undulation of the undulating drum 77 causes the angle bracket 167 to undulate, the spring tube 165 elastically supports the angle bracket 167 through its innate elasticity, to damp the undulation of the angle bracket 167. Therefore, the undulating range of the undulating drum 77 connected to the angle bracket 167 is limited. Of course, the undulation range of the floorboard 80 connected to the undulating drum 77 is controlled together with the undulation of the undulating drum 77.

The first end and second end connecting members may further include a washer W, as shown in the enlarged exploded perspective view. Also, an elastic tube 173 may be further included. This washer W and elastic tube 173 may be provided together or selectively provided. Here, the washer W and elastic tube 173 will be described in further detail.

First, the washer W has the u-bolt 171a inserted therein (as shown in the exploded perspective view), and presses against the outer surface of the end shafts 165a and 165b of the spring tube 165 (as shown in the enlarged sectional view). This washer W may be formed of a metal material, or a rubber or plastic material having a degree of elasticity. The washer W, as shown in the exploded perspective view, may be provided as a double washer, and may have a shaft groove H formed in a central portion thereof, through which the end shafts 165a and 165b pass and are enclosed. Thus, in the configuration with the shaft groove H is formed on the washer W, the end shafts 165a and 165b of the spring tube 165 can be pressed more securely against the washer W.

Next, the elastic tube 173 is fitted over the end shafts 165a and 165b of the spring tube 165, as shown in the exploded perspective view. This elastic tube 173 may be formed of a rubber or soft plastic material having a degree of elasticity. The elastic tube 173 is fitted over the end shafts 165a and 165b to protect the end shafts 165a and 165b with its innate elasticity. When the spring tube 165 undulates due to the undulating of the undulating drum 77, the elastic member 173 prevents the end shafts 165a and 165b from directly rubbing against the angle bracket 167 or the mounting angle 173. Accordingly, when the spring tube 165 undulates, the noise is not generated due to the elastic tube 173. That is, the elastic tube 173 protects the end shafts 165a and 165b from friction.

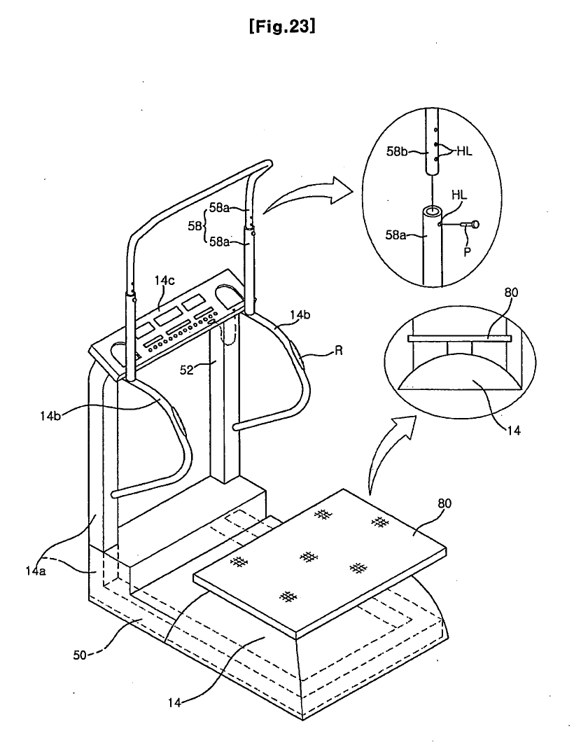

FIG. 23 is a perspective view showing the assembly of a post on an exercise machine for burning fat and strengthening muscle according to an embodiment of the present invention. That is, FIG. 23 shows a metal bar 58 added to the exercise machine shown in FIG. 1. That is, a metal bar 58 may be installed on the exercise machine for burning fat and exercising muscles according to this embodiment of the present invention. Therefore, the added metal bar 58 will be described with respect to FIG. 23.

As shown in FIG. 23, the metal bar 58 is installed on the end portions of the handles 14b to allow horizontal bar exercise. This metal bar 58 is supported on the post 14a though the handle 14b. Accordingly, even when horizontal exercise performed using the metal bar 58 imposes a load on the exercise machine, the machine can fully support such a load.

Likewise, the metal bar 58 may be installed on the post 14a instead of on the handles 14b. However, as shown in FIG. 23, the metal bar 58 may be installed on the end portion of the handle 14b to support the center of a load during horizontal bar exercising.

This metal bar 58 may be removable, as shown in the enlarged image in FIG. 23. When the metal bar 58 is made to be removable, the height of the metal bar may be adjusted according to a user's height.

Here, reference numbers 58a and 58b are respectively a lower bar and an upper bar for fitting together, H signifies fastening holes for fastening the lower and upper bars 58a and 58b together, and P signifies a fastening pin for fastening into the fastening holes H. That is, the metal bar 58 includes the fastening holes H formed correspondingly in the lower and upper bars 58a and 58b, respectively, and a fastening pin P.

This fastening bar 58, as shown in the enlarged view, includes the upper bar 58b that inserts into the lower bar 58a, and is raised and lowered therein. Here, when the fastening holes H formed in the upper and lower bars 58b and 58a are aligned, the fastening pin P is fastened into the aligned fastening holes H to secure the upper bar 58b. Thus, the height of the metal bar 58 is adjustable.

The above-described metal bar 58 provides horizontal bar exercise to users. Therefore, not only are fat burning and muscle strengthening exercises provided by the exercise machine according to embodiments of the present invention, but horizontal bar exercising is also provided.

The base 14 sealing the base frame 50 may be formed in a roughly hemispheric shape, as depicted in FIG. 23. When the base 14 is thus formed in a hemispheric shape, the floorboard 80 is exposed in a protruding manner on the upper portion of the base 14. Accordingly, because only the floorboard 80 is exposed to a user on the base, the user is easily able to mount the floorboard 80.

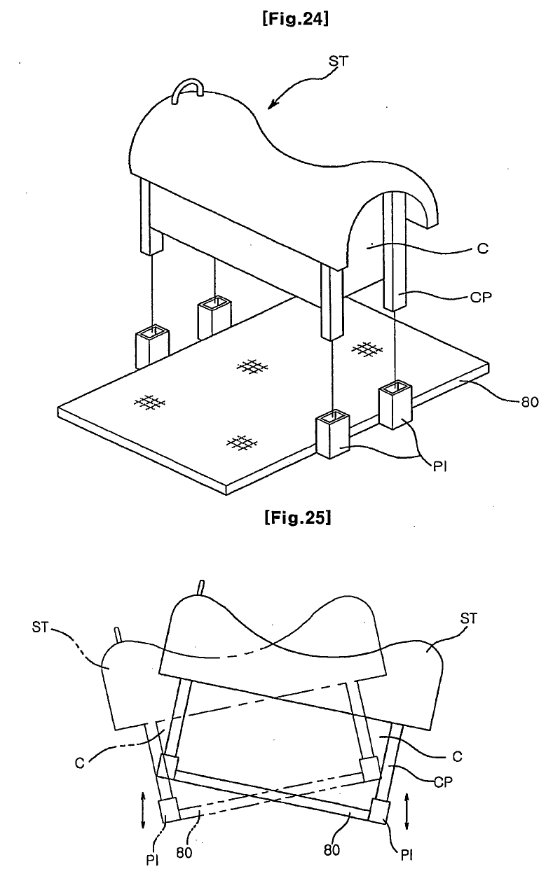

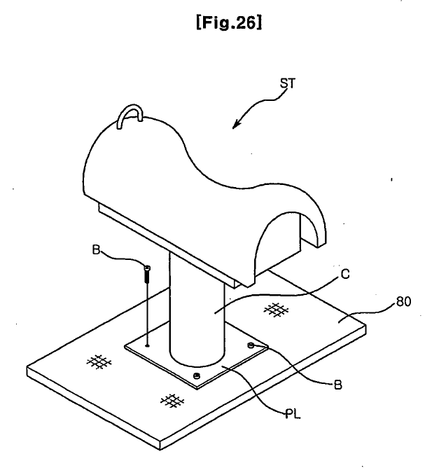

FIG. 24 is an exploded perspective view showing the assembly of a seat to an exercise machine for burning fat and strengthening muscle according to an embodiment of the present invention, and FIG. 25 is side view showing the seat in FIG. 24 during operation. FIGS. 24 and 26 show the addition of a seat ST to the exercise machine for burning fat and strengthening muscles, according to embodiments of the present invention. That is, in this embodiment of the present invention, a seat ST may be installed on the exercise machine for burning fat and strengthening muscles. Therefore, the added seat ST will be described with reference to the drawings.

Referring to FIG. 24, a seat ST is installed on the undulating floorboard 80 to enable a user to sit. This seat ST may be installed on the floorboard 80 through a seat frame C, or installed directly on the floorboard 80.

Here, the seat ST is provided with protrusions CP protruding from the lower portion of a seat frame C, as shown in FIG. 24, and the floorboard 80 is provided with insert tubes P in which the protrusions CP are inserted to install the seat ST on the floorboard 80. That is, the seat ST is installed on the floorboard 80 through the protrusion CP and the insert tube P. Accordingly, the seat ST can easily be installed and removed on the floorboard 80. This seat ST moves 3-dimensionally together with the floorboard 80 when the latter undulates.

Here, the seat ST may be designed with safety as a top priority. This is in order to provide a fun atmosphere, such as that provided by a rodeo by riding the undulating seat, while at the same time providing exercise benefits. That is, a fun exercise experience can be obtained.

Referring to FIG. 25, the seat ST fixed to the floorboard 80 through the seat frame C can move in all directions through the movement of the floorboard 80. Accordingly, the safety-minded seat ST provides an exercising experience equivalent to participating in a rodeo. That is, through the seat ST a user can experience an exercise session similar to riding in a rodeo.

FIG. 26 is a perspective view of the seat in FIG. 24 according to another embodiment of the present invention. This seat ST according to another embodiment of the present invention includes a flange PL formed below the seat frame C that is bolted on the floorboard 80, so that it is removable. That is, the seat ST shown in FIG. 26 is different from the embodiment in FIG. 24 in that the flange PL is provided below the seat frame C.

### INDUSTRIAL APPLICABILITY

The above-described exercise machine for burning fat and strengthening muscles according to the present invention has a simple structure for a driving unit, facilitating its installation, provides integration of components to prevent breaking and rupture of components, and provides a safe and smooth 3-dimensional exercising device for burning body fat and strengthening muscles.

Also, the exercise machine provides convenience and better exercising effects by allowing the adjusting of the range of 3-dimensional movement of the floorboard even during operation.

Furthermore, undulation of the floorboard can be safely controlled using the undulation limiter, so that excessive undulation of the floorboard leading to user injury can be prevented.

Moreover, when a metal bar is installed on the base frame, not only undulating exercise can be provided, but also horizontal bar exercises can be provided. Additionally, the addition of a seat installed on the floorboard can provide an entertaining exercising experience similar to riding a horse.

It will be apparent to those skilled in the art that various modifications and variations can be made in the present invention. Thus, it is intended that the present invention covers the modifications and variations of this invention provided they come within the scope of the appended claims and their equivalents.

1. An exercise machine for burning fat and strengthening muscles, comprising:
a base frame being substantially horizontal;
a drive unit disposed on one side of the base frame, for providing driving force;
an undulator disposed at a top of the base frame, for undulating three-dimensionally through the driving force provided by the drive unit; and
a floorboard connected to the undulator and undulating according to the three-dimensional undulating of the undulator, for providing a user mounted thereon with fat burning and muscle strengthening three-dimensional exercise.

2. The exercise machine according to claim 1, wherein the undulator comprises:
a rotating drum rotating on the base frame through the driving force provided by the drive unit;
a fixing member for rotatably fixing the rotating drum on the base frame;
a rolling disk formed integrally and rotating with the rotating drum, the rolling disk providing three-dimensional undulation while rotating along a circular direction;
an undulating drum supported on the rolling disk and undulating three-dimensionally according to the undulation provided by the rolling disk, the undulating drum connected to the floorboard, for moving the floorboard three-dimensionally; and
a supporting member for supporting the undulating drum on the rolling disk.

3. The exercise machine according to claim 2, wherein the supporting member comprises:
a disk shaft provided integrally with the rolling disk and passing through the undulating drum in an axial direction thereof; and
a supporting ledge protruding outward from the disk shaft, for supporting a lower portion of the undulating drum.

4. The exercise machine according to claim 3, further comprising a journal bearing for preventing an inner surface of the undulating drum through which the disk shaft passes from generating friction with an outer surface of the disk shaft.

5. The exercise machine according to claim 1, wherein the undulator comprises:
a rotating drum for rotating on the base frame through the driving force provided by the drive unit;
a fixing member for rotatably fixing the rotating drum on the base frame;
a rolling disk integrally formed with and rotating with the rotating drum, the rolling disk forming three-dimensional undulation while rotating along a circular direction, and connected to the floorboard for moving the floorboard three-dimensionally; and
a roller member rotatably fixed to the floorboard and supported by the rolling disk.

6. The exercise machine according to claim 2 or 5, wherein
the drive unit comprises:
a motor installed on the base frame; and
a power transmission member for transmitting a driving power of the motor to the rotating drum, wherein the power transmission member is a belt wound between a drive shaft of the motor and the rotating drum.

7. The exercise machine according to claim 2 or 5, wherein the fixing member comprises:
a through shaft provided on the base frame and passing through the rotating drum in an axial direction thereof; and
a supporting ledge protruding outward from the through-shaft and rotated by the drive unit, for supporting a lower portion of the rotating drum.

8. The exercise machine according to claim 7, further comprising a journal bearing for preventing an inner surface of the rotating drum, through which the through shaft passes, from generating friction with the outer surface of the through shaft.

9. The exercise machine according to claim 7, further comprising an incliner for providing an incline to the through shaft and the drive unit, wherein the incliner comprises:
a hinge for fixing the through shaft to the base frame in an eccentrically rotatable state;
a vertical bracket vertically provided on the base frame;
a cylinder fixed at both ends thereof through hinges to the bracket and the eccentrically rotatable through shaft; and
a link bracket connecting the drive unit to the through shaft.

10. The exercise machine according to claim 2 or 5, wherein the fixing member comprises:
a through shaft provided on the base frame and passing through the rotating drum in an axial direction thereof; and
a foot bearing installed on the through shaft, for rotatably supporting a vertical load of the rotating drum rotated by the drive unit.

11. The exercise machine according to claim 2 or 5, wherein the rolling disk is bolted and fixed to the rotating drum, has an uneven, inclined thickness, is integrally formed with and rotates with the rotating drum, and forms a three-dimensional undulation while rotating along a circular direction.

12. The exercise machine according to claim 5, wherein the floorboard is fastened to the rolling disk with a through-type fastening member including a head that catches on the floorboard.

13. The exercise machine according to claim 1, further comprising an undulation limiter for limiting a three-dimensional undulation of the floorboard through the undulator of the base frame.

14. The exercise machine according to claim 13, wherein the undulation limiter is an elastic member connecting the floorboard to the base frame, for damping and limiting the undulation of the floorboard through an innate elasticity of the undulation limiter.

15. The exercise machine according to claim 13, wherein the undulation limiter is an elastic member directly connecting one side of the undulator and both ends of the base frame, for damping undulation of the undulator and limiting the undulation of the floorboard connected to the undulator through an innate elasticity of the undulation limiter.

16. The exercise machine according to claim 13, wherein the undulation limiter comprises:
a vertical rod installed on the base frame and spaced apart from the undulator; and
an elastic connecting belt connected at either end thereof to the vertical rod and one side of the undulator, for maintaining a tension therebetween.

17. The exercise machine according to claim 13, wherein the undulation limiter comprises:
a load bearing including a fixing portion installed vertically on the base frame and a moving portion connected at a right angle with one end of the fixing portion and eccentrically undulating about the end of the fixing portion; and
a coupling member for coupling the moving portion of the load bearing to one side of the undulator, wherein the coupling member includes:
a fixing bracket for fixing the coupling member to the one side of the undulator; and
a connecting pin for connecting the fixing bracket and the moving portion of the load bearing.

18. The exercise machine according to claim 13, wherein the undulation limiter comprises:
a mounting angle for fixing the undulation limiter on the base frame in a separated state from the undulator; and
a spring tube connected at each end thereof respectively to the mounting angle and one side of the undulator to be substantially horizontal in disposition, the spring tube for damping the undulation of the undulator through an innate elasticity of the spring tube and limiting the undulation of the floorboard through the undulator.

19. The exercise machine according to claim 18, further comprising a first side connecting member for connecting one end of the spring tube to one side of the undulator, wherein the first side connecting member includes:
an angle bracket directly connected at one side thereof to an outer surface of the undulator;
a first inserting protrusion coupled to the other side of the angle bracket and inserted into an end of the spring tube, for connecting the spring tube to the angle bracket; and
a coupling shaft protruding from the other side of the angle bracket and passing through the first inserting protrusion, for integrally coupling the first inserting protrusion to the angle bracket.

20. The exercise machine according to claim 18, further comprising a first end connecting member for connecting one end of the spring tube to the one side of the undulator, wherein the first end connecting member includes:
an angle bracket directly connected at one end thereof to an outer surface of the undulator;
a first end shaft forming a substantially right angle to an axial direction of the spring tube, and integrally provided on the one end of the spring tube; and
a fastening member enclosing the first end shaft and fastened to the angle bracket, for connecting the first end shaft to the angle bracket.

21. The exercise machine according to claim 18, further comprising a second end connecting member for connecting the other end of the spring tube to the mounting angle, wherein the second end connecting member includes:
a second inserting protrusion fixed to the mounting angle, and inserted into the other end of the spring tube, for connecting the spring tube to the mounting angle; and
a fixing shaft protruding from the mounting angle, and passing through the second inserting protrusion, for integrally coupling the second inserting protrusion to the mounting angle.

22. The exercise machine according to claim 19 or 21, wherein the inserting protrusion further comprises a flange for supporting an end of the spring tube.

23. The exercise machine according to claim 18, further comprising a second end connecting member for connecting the other end of the spring tube to the mounting angle, wherein the second end connecting member includes:
a second end shaft forming a substantially right angle to an axial direction of the spring tube, and integrally provided on the other end of the spring tube; and
a fastening member enclosing the second end shaft and fastened to the mounting angle, for connecting the second end shaft to the mounting angle.

24. The exercise machine according to claim 20 or 23, further comprising a washer for fitting over the fastening member and pressing against and supporting an outer surface of the end shaft.

25. The exercise machine according to claim 20 or 23, further comprising an elastic tube for fitting over the end shaft and protecting the end shaft through an innate elasticity of the elastic tube.

26. The exercise machine according to claim 1, further comprising a metal bar installed on the base frame, for allowing horizontal bar exercise.

27. The exercise machine according to claim 1, further comprising a seat detachably fixed to the floorboard, for undulating three-dimensionally together with the floorboard.
